(19) United States
(12) Patent Application Publication
(10) Pub. No.: US 2026/0316744 A1
(43) Pub. Date: Oct. 15, 2026

(54) DEVICE AND METHOD FOR CONTROLLING A HYBRID ELECTRIC VEHICLE, AND A HYBRID ELECTRIC VEHICLE AND A STORAGE MEDIUM INCLUDING THE SAME

(71) Applicants: HYUNDAI MOTOR COMPANY, Seoul (KR); KIA CORPORATION, Seoul (KR)

(72) Inventors: Soo Bang Lee, Hwaseong-si (KR); Se Geun Kim, Hwaseong-si (KR)

(73) Assignees: HYUNDAI MOTOR COMPANY, Seoul (KR); KIA CORPORATION, Seoul (KR)

(21) Appl. No.: 19/340,545

(22) Filed: Sep. 25, 2025

(30) Foreign Application Priority Data
Apr. 9, 2025 (KR) 10-2025-0046032

(51) Int. Cl. B60W 20/16; B60W 10/06; B60W 10/08

(52) U.S. Cl. CPC B60W 20/16; B60W 10/06; B60W 10/08; B60W 2510/0657; B60W 2510/0676; B60W 2510/068; B60W 2510/244; B60W 2710/0622; B60W 2710/0627; B60W 2710/0633; B60W 2710/083; B60W 2710/248

(57) ABSTRACT

A device for controlling a hybrid electric vehicle includes a controller configured to control an air intake amount of an engine to decrease the air intake amount of the engine as a temperature of the engine or an exhaust structure of the hybrid electric vehicle increases. The controller is further configured to control torque of a motor based on a state of charge of a battery of the hybrid electric vehicle to compensate for at least a portion of torque reduction of the engine caused by a decrease in the air intake amount of the engine.

### CROSS-REFERENCE TO RELATED APPLICATION(S)

This application claims benefit of and priority to Korean Patent Application No. 10-2025-0046032, filed on Apr. 9, 2025 in the Korean Intellectual Property Office, the disclosure of which is incorporated herein by reference in its entirety.

### FIELD

The present disclosure relates to a device and method for controlling a hybrid electric vehicle, and a hybrid electric vehicle and a storage medium including the same.

### BACKGROUND

The statements in this section merely provide background information related to the present disclosure and may not constitute prior art.

Exhaust-system components, including the exhaust manifolds of the engines of common vehicles, are susceptible to heat damage due to the high temperature of exhaust gas discharged from the engine. In addition, components surrounding the engine exhaust system in the engine bay where the engine is mounted are also likely to be damaged by heat transferred from exhaust gas, and heat damage mainly occurs in components made of plastic or rubber. Conventional vehicles may prevent the aforementioned heat damage through Catalyst Overheating Protection (COP) control.

### SUMMARY

An aspect of the present disclosure provides a device and method for controlling a hybrid electric vehicle, as well as a hybrid electric vehicle and a storage medium including the same. The present disclosure avoids or prevents damage to an engine and/or an exhaust structure caused by high temperature, while securing or improving a exhaust gas purification rate, the overall torque of the hybrid electric vehicle, and the stability or responsiveness of the acceleration as perceived by a driver when an accelerator pedal is pressed.

According to an aspect of the present disclosure, a device for controlling a hybrid electric vehicle includes a controller configured to control an air intake amount of an engine to decrease the air intake amount of the engine as a temperature of the engine or a temperature of an exhaust structure of the hybrid electric vehicle increases. The controller is further configured to control torque of at least one motor, which outputs torque based on energy of a battery of the hybrid electric vehicle, to compensate for at least a portion of torque reduction of the engine caused by a decrease in the air intake amount of the engine.

In an embodiment, the controller may control a lambda value, defined as a ratio of an actual air-fuel ratio to a theoretical air-fuel ratio, to track or maintain a value of 1.

In an embodiment, the controller may control the air intake amount and an input fuel amount of the engine so that the air intake amount and the input fuel amount of the engine decrease stepwise as the temperature of the engine or the temperature of the exhaust structure increases stepwise within a predetermined temperature range.

In an embodiment, the controller may control the air intake amount of the engine by adjusting an operating point of the engine as the temperature of the engine or the exhaust structure increases within a first temperature range of a predetermined temperature range. The controller may control the air intake amount of the engine with greater priority than the operating point adjustment as the temperature of the engine or the exhaust structure increases within a second temperature range of the predetermined temperature range.

In an embodiment, the controller may determine, based on a state of charge (SOC) of the battery, whether the at least one motor is configured to compensate for at least a portion of the torque reduction of the engine.

In an embodiment, the controller may control the torque of the at least one motor such that a compensation ratio, at which the at least one motor compensates for at least a portion of the torque reduction of the engine, is determined based on the state of charge (SOC) of the battery.

In an embodiment, the controller may determine whether the at least one motor is configured to compensate for at least a portion of the torque reduction of the engine based on whether a torque securing mode is activated.

In an embodiment, the at least one motor may include: a first motor providing torque to rear wheels of the hybrid electric vehicle, and a second motor connected between the engine and a transmission and providing torque to front wheels of the hybrid electric vehicle. The controller may control torque of at least one of the first motor or the second motor to compensate for at least a portion of the torque reduction of the engine.

In an embodiment, the controller may control charging of the battery when torque of the engine, reduced due to reduction in the air intake amount, is equal to or greater than a required torque. The controller may control discharging of the battery when the torque of the engine, reduced due to the reduction in the air intake amount, is less than the required torque.

According to an aspect of the present disclosure, a hybrid electric vehicle includes: an engine; an exhaust structure forming an exhaust path of the engine; a sensor unit sensing a temperature of the engine and the exhaust structure; a battery; at least one motor configured to output torque based on energy of the battery; and a controller controlling an air intake amount of the engine to reduce the air intake amount of the engine as a temperature of the engine or a temperature of the exhaust structure increases. The controller is further configured to control a torque of the at least one motor to compensate for at least a portion of torque reduction of the engine caused by a decrease in the air intake amount of the engine.

In an embodiment, the controller may determine at least one of whether the at least one motor is configured to compensate for at least a portion of the torque reduction of the engine or a compensation ratio, based on a state of charge (SOC) of the battery.

In an embodiment, the controller may control the air intake amount of the engine so that an input fuel amount of the engine decreases as the temperature of the engine or the exhaust structure increases. The controller may control a lambda value, obtained by dividing an actual air-fuel ratio by a theoretical air-fuel ratio, to track or maintain a value of 1.

In an embodiment, the controller may control the air intake amount and the input fuel amount of the engine so that the air intake amount and the input fuel amount of the engine decrease stepwise as the temperature of the engine or the exhaust structure increases stepwise within a predetermined temperature range.

In an embodiment, the controller may control charging of the battery when torque of the engine, decreased due to a decrease in the air intake amount, is equal to or greater than a required torque. The controller may control discharging of the battery when the torque of the engine, decreased due to the decrease in the air intake amount, is less than the required torque.

In an embodiment, the at least one motor may include: a first motor providing torque to rear wheels of the hybrid electric vehicle, and a second motor connected between the engine and a transmission and configured to provide torque to front wheels of the hybrid electric vehicle. The controller may control torque of at least one of the first motor or the second motor to compensate for at least a portion of the torque reduction of the engine.

According to an aspect of the present disclosure, a method for controlling a hybrid electric vehicle includes: controlling an air intake amount of an engine to reduce the air intake amount as a temperature of the engine or a temperature of an exhaust structure of the hybrid electric vehicle increases. The method further includes controlling torque of a motor configured to output the torque based on energy of a battery of the hybrid electric vehicle to compensate for at least a portion of torque reduction of the engine caused by a decrease in the air intake amount of the engine.

In an embodiment, controlling the torque of the motor may include determining at least one of whether the motor is configured to compensate for at least a portion of the torque reduction of the engine or a compensation ratio based on a state of charge (SOC) of the battery.

In an embodiment, controlling the air intake amount may include decreasing the air intake amount of the engine stepwise as the temperature of the engine or the exhaust structure increases stepwise within a predetermined temperature range. Controlling the torque of the motor may include determining a compensation ratio, at which the motor compensates for at least a portion of the torque reduction of the engine in proportion to the state of charge of the battery based on determining that the state of charge of the battery is lower than a first reference and higher than a second reference. Controlling the torque of the motor may include setting the compensation ratio to a maximum value based on determining that the state of charge of the battery is higher than the first reference, and setting the compensation ratio to a minimum value based on determining that the state of charge of the battery is lower than the second reference.

In an embodiment, controlling the torque of the motor may include controlling the air intake amount of the engine so that an input fuel amount of the engine decreases as the temperature of the engine or the exhaust structure increases, and performing lambda control so that a lambda value obtained by dividing an actual air-fuel ratio by a theoretical air-fuel ratio follows a value of 1.

According to an aspect of the present disclosure, a non-transitory computer-readable storage medium stores one or more programs recorded thereon, including commands or instructions, when executed by a processor, cause the processor to perform the method of controlling a hybrid electric vehicle.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1A to 1C are diagrams illustrating a hybrid electric vehicle according to an embodiment;

FIG. 2 is a diagram illustrating conditions for determining whether torque compensation of a motor (and/or a compensation ratio) is to be performed by a device and method for controlling a hybrid electric vehicle according to an embodiment;

FIG. 3 is a graph illustrating lambda control to make a lambda value (actual air-fuel ratio/theoretical air-fuel ratio) follow “1” by using a device and method for controlling a hybrid electric vehicle according to an embodiment follows 1;

FIG. 4 is a flowchart illustrating an operation of a device and method for controlling a hybrid electric vehicle according to an embodiment;

FIG. 5 is a flowchart illustrating a more detailed operation of a device and method for controlling a hybrid electric vehicle according to an embodiment;

FIG. 6 is a flowchart illustrating an operation in which a device and method for controlling a hybrid electric vehicle according to an embodiment determines whether to charge or discharge a battery based on an engine operating point determined according to control of an engine air intake amount;

FIG. 7 is a flowchart illustrating an operation in which a device and method for controlling a hybrid electric vehicle according to an embodiment gradually reduces an engine intake air amount in stages according to a monitored temperature;

FIG. 8 is a flowchart illustrating an operation in which a device and method for controlling a hybrid electric vehicle according to an embodiment determines whether to compensate for the motor torque and/or a compensation ratio based on a battery state of charge (SOC); and

FIG. 9 is a block diagram illustrating a controller of a device and method for controlling a hybrid electric vehicle according to an embodiment, implemented as a computing device.

### DETAILED DESCRIPTION

The disclosed embodiments may have various modifications and may have various embodiments, and thus specific embodiments are illustrated in the drawings and described in detail. However, this is not intended to limit the disclosed embodiments to specific embodiments, but should be understood to include all modifications, equivalents, and substitutes included in the spirit and technical scope of the disclosed embodiments.

The terms first, second, etc. may be used to describe various components, but the components should not be limited by the terms. The terms are used only for the purpose of distinguishing one component from another. For example, without departing from the scope of the disclosed embodiments, the first component may be referred to as the second component, and similarly, the second component may also be referred to as the first component. The term ‘and/or’ includes a combination of a plurality of related described items or any of a plurality of related described items.

The terms used in this application are used only to describe detailed embodiments and are not intended to limit the disclosed embodiments. The singular expression includes the plural expression unless the context clearly indicates otherwise. In this application, the terms “comprises,” “include,” “have,” or the like are intended to specify the presence of a feature, number, step, operation, component, part, or combination thereof described in the specification, but should be understood as not excluding in advance the possibility of the presence or addition of one or more other features, numbers, steps, operations, components, parts, or combinations thereof.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

Unless otherwise defined, all terms used herein, including technical or scientific terms, have the same meaning as commonly understood by a person of ordinary skill in the art to which the disclosed embodiment belongs. Terms commonly used and defined in dictionaries should be interpreted as having a meaning consistent with the meaning they have in the context of the relevant technology, and shall not be interpreted in an ideal or excessively formal sense unless explicitly defined in this application.

In this specification, a vehicle (including an electric vehicle) means various vehicles that move a transported object such as a person, an animal, or an object from a starting point to a destination. Such vehicles are not limited to vehicles that run on roads or tracks.

Hereinafter, some embodiments of the present disclosure are described in more detail with reference to the attached drawings.

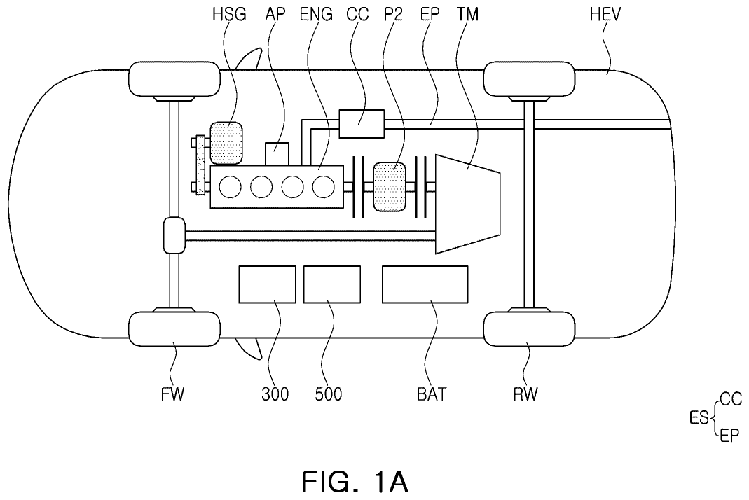

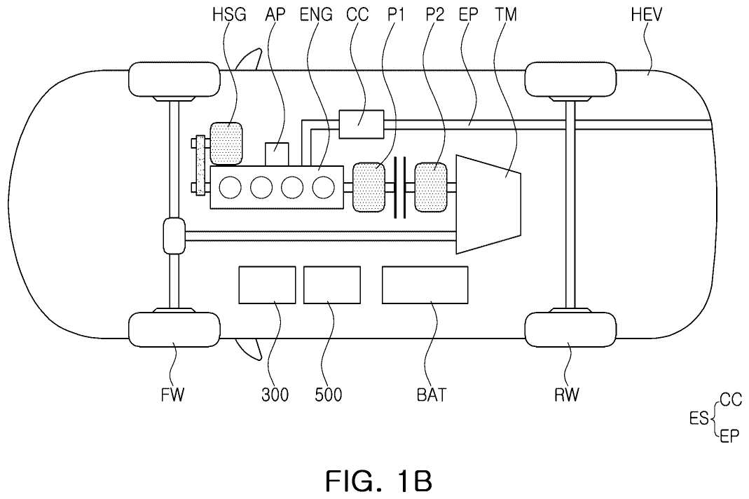

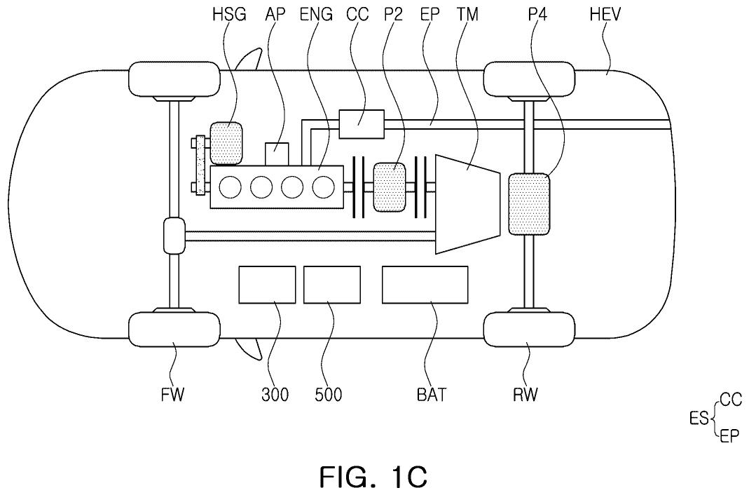

Referring to FIG. 1A, a hybrid electric vehicle (HEV) according to an embodiment disclosed herein may include an engine (ENG), an exhaust structure (ES), a sensor unit 300, a battery (BAT), a motor P2, and a controller 500. Depending on the design, the hybrid electric vehicle (HEV) may be implemented as a plug-in hybrid electric vehicle.

The engine (ENG) may provide torque to at least one of the front wheels (FW) or the rear wheels (RW) of the hybrid electric vehicle (HEV). For example, the engine (ENG) may provide torque only to the front wheels (FW) of the hybrid electric vehicle (HEV). In another form, the engine (ENG) may provide torque to a structure (for example, a drive shaft connected between the front wheels (FW) and the rear wheels (RW)) for providing torque to the front wheels (FW) as well as the rear wheels (RW). When the driver of the hybrid electric vehicle (HEV) applies more pressure to the accelerator pedal, the throttle opening rate of the engine (ENG) may be higher, the amount of fuel injected to the engine (ENG) may be increased, and the engine (ENG) may provide greater torque to one (for example, the front wheel) of the front wheels (FW) and the rear wheels (RW) of the hybrid electric vehicle (HEV).

The exhaust structure(ES) may provide an exhaust path for the engine (ENG) and may include an exhaust pipe (EP) and/or a catalytic converter (CC). The engine (ENG) may combust fuel mixed with intake air to output torque, and may discharge exhaust gas generated by the combustion to the outside of the hybrid electric vehicle (HEV) through the exhaust structure (ES). At this time, the catalytic converter (CC) may convert pollutants (for example, carbon monoxide, hydrocarbons, nitrogen oxides) of the exhaust gas into substantially harmless substances by using a precious metal as a catalyst. As the temperature of the exhaust gas and/or the temperature of the catalyst increases, the possibility of damage to the engine (ENG) and/or the exhaust structure (ES) due to the high temperature increases.

The sensor unit 300 may sense the temperature of the engine (ENG) and/or the exhaust structure (ES). For example, the sensor unit 300 may include at least one temperature sensor disposed in the engine (ENG) and/or the exhaust structure (ES), and may generate an electrical value (for example, voltage, current, resistance) corresponding to the temperature in the vicinity of the temperature sensor. The sensor unit 300 may transmit the electrical value to the controller 500 (for example, output within the circuit, wired transmission, wireless transmission).

The controller 500 may control the air intake amount of the engine (ENG) so that the air intake amount of the engine (ENG) decreases as the temperature of the engine (ENG) and/or the exhaust structure (ES) increases. As the air intake amount of the engine (ENG) decreases, combustion within the engine (ENG) may be reduced, leading to a decrease in the temperature of the exhaust gas and/or the temperature of the catalyst, and thus lowering the temperature of the engine (ENG) and/or the exhaust structure (ES). Accordingly, the controller 500 may avoid or prevent overheating of the engine (ENG) and/or the exhaust structure (ES), and may prevent the engine (ENG) and/or the exhaust structure (ES) from being damaged by high temperature.

For example, the controller 500 may include an Engine Control Unit (ECU) and/or an Engine Control Module (ECM), may implement an Engine Management System (EMS), and may store in advance the control logic used by at least one of the ECU, the ECM, and the EMS. For example, the controller 500 may store optimal efficiency area data of the engine (ENG), and may store optimal operating point data of the engine (ENG) based on the optimal efficiency area data. The control logic may include an algorithm for controlling the engine (ENG) to follow the optimal operating point based on the optimal efficiency area data and/or the optimal operating point data.

As the air intake amount of the engine (ENG) decreases, the optimal operating point of the engine (ENG) may also change. Accordingly, the optimal operating point of the engine (ENG) may change depending on the temperature of the engine (ENG) and/or the exhaust structure (ES). For example, the controller 500 may determine the optimal operating point based on the temperature of the engine (ENG) and/or the exhaust structure (ES), and may control the engine (ENG) to follow the determined optimal operating point.

For example, the controller 500 may control the air intake amount of the engine (ENG) by controlling the air pump (AP) of the engine (ENG), and may control the input fuel amount of the engine (ENG) so that the engine (ENG) follows the optimal operating point. For example, the controller 500 may control the air intake amount of the engine (ENG) so that the input fuel amount of the engine (ENG) decreases as the temperature of the engine (ENG) and/or the exhaust structure (ES) increases.

When the air intake amount and/or the input fuel amount of the engine (ENG) decrease, the torque of the engine (ENG) may also decrease. The hybrid electric vehicle (HEV) may include a motor P2 that outputs torque using the energy of the battery (BAT), and the decrease in the torque of the engine (ENG) may be compensated for.

A device for controlling a hybrid electric vehicle according to an embodiment may include a controller 500 which controls an air intake amount of an engine (ENG) so that the air intake amount of the engine (ENG) decreases as the temperature of an engine (ENG) and/or an exhaust structure (ES) of a hybrid electric vehicle (HEV) increases. The controller controls a torque of a motor P2 to compensate for at least a portion of torque reduction of the engine (ENG) caused by a decrease in the air intake amount of the engine (ENG).

Referring to FIGS. 1A and 4, according to an embodiment, a method of controlling a hybrid electric vehicle may include: controlling an air intake amount of an engine (ENG) in an operation S110, so that the air intake amount of the engine (ENG) decreases as a temperature of an engine (ENG) and/or an exhaust structure (ES) of a hybrid electric vehicle (HEV) increases. The method may include controlling a torque of a motor P2 to compensate for at least a portion of torque reduction of the engine (ENG) due to a decrease in the air intake amount of the engine (ENG) in an operation S120.

Accordingly, the device and method for controlling a hybrid electric vehicle according to the disclosed embodiment, and the hybrid electric vehicle (HEV) and the storage medium including the same, may prevent the engine (ENG) and/or the exhaust structure (ES) from being damaged by high temperature, while securing a purification rate for exhaust gas or securing (or improving) the overall torque of the hybrid electric vehicle (HEV), and stably securing (or improving) the acceleration feeling felt when the driver applies pressure to the accelerator pedal (e.g., when the driver accelerates the vehicle).

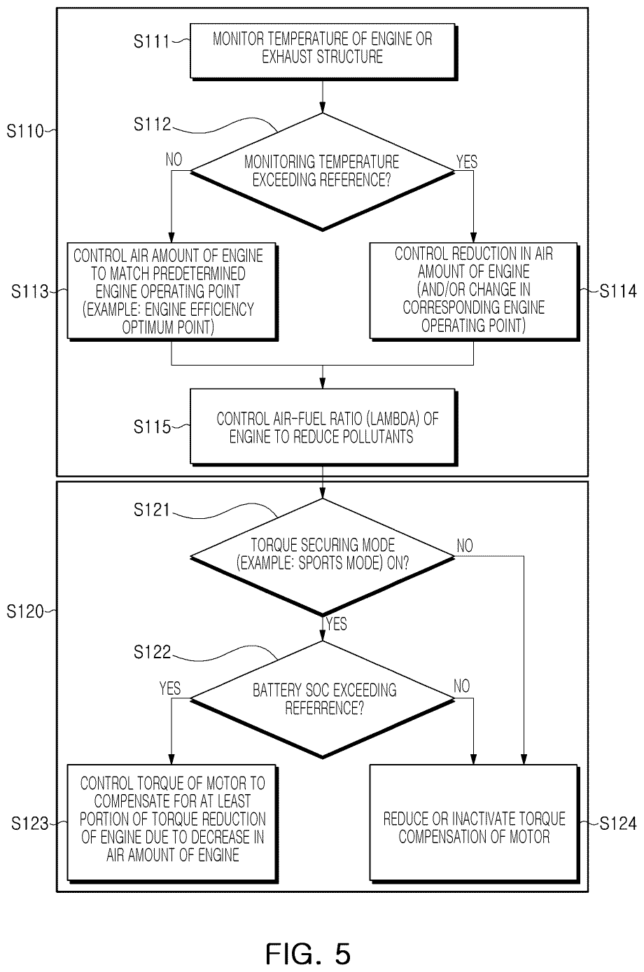

Referring to FIG. 1A and FIG. 5, in operation S110, the controller 500 may monitor the temperature of an engine (ENG) and/or an exhaust structure (ES) via a sensor unit 300 in an operation S111, determine whether the monitored temperature exceeds a predetermined reference (in an operation S112), control the air intake amount of the engine (ENG) to match a predetermined engine operating point (for example, an engine efficiency optimum point) (in an operation S113). When the monitored temperature is equal to or lower than the reference, the controller 500 may control a reduction in the air intake amount of the engine (ENG) (and/or a change in the corresponding engine operating point) (in an operation S114). When the monitored temperature exceeds the reference, and the controller 500 may control the air-fuel ratio (lambda) of the engine (ENG) to reduce pollutants (for example, carbon monoxide, hydrocarbons, nitrogen oxides) of exhaust gas (in an operation S115).

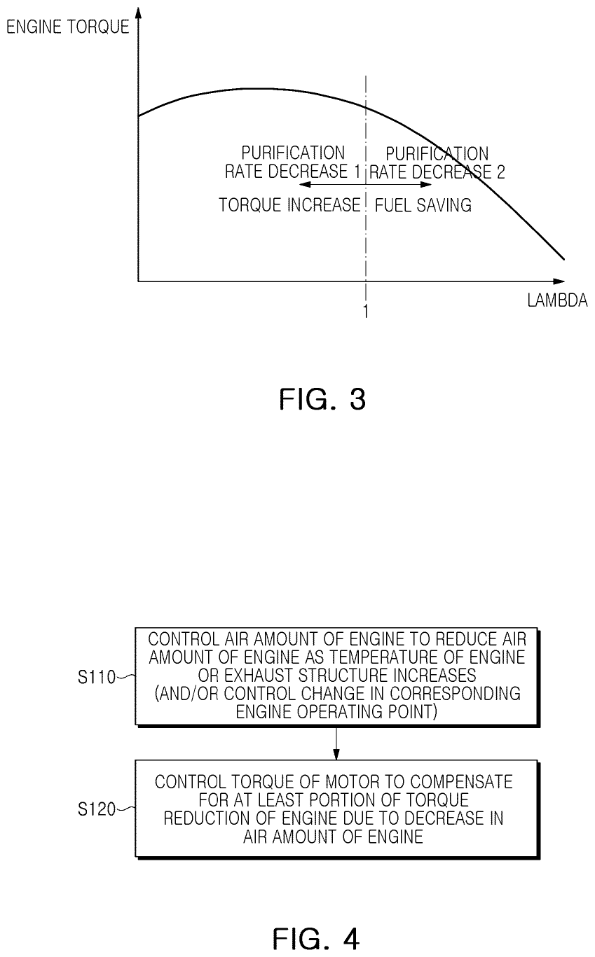

Referring to FIGS. 1A, 3, and 5, in operation S110, the controller 500 (see FIG. 1A) may perform lambda control (in S115 of FIG. 5) so that the lambda value obtained by dividing the actual air-fuel ratio by the theoretical air-fuel ratio tracks or maintains a value of 1. If the lambda value is significantly lower than 1, the torque of the engine (ENG) may increase, but the purification rate for some pollutants (for example, carbon monoxide, hydrocarbons) may decrease. If the lambda value is significantly higher than 1, the fuel economy of the engine (ENG) may be improved, but the purification rate for other pollutants (for example, nitrogen oxides) may decrease. When the lambda value is controlled to follow 1, the overall purification rate for the exhaust gas may be secured.

For example, assuming that the fuel is gasoline, the theoretical air-fuel ratio may be 14.7(air): 1(fuel). In the case of a rich state in which the air-fuel ratio is lower than the theoretical air-fuel ratio (i.e., Lambda value is less than “1”), the controller 500 (see FIG. 1A) may control the lambda value to get closer to 1 by reducing the fuel injection amount for the engine (ENG). In the case of a lean state in which the air-fuel ratio is greater than the theoretical air-fuel ratio(i.e., Lambda value is greater than “1”), the controller 500 (see FIG. 1A) may control the lambda value to get closer to 1 by increasing the fuel injection amount for the engine (ENG).

For example, in operation S110 in FIG. 5, when the controller 500 (see FIG. 1A) controls the reduction of the air intake amount of the engine (ENG) (and/or the change in the corresponding engine operating point) as the monitored temperature exceeds the reference (in an operation S114), the controller 500 (see FIG. 1A) may control the air-fuel ratio (lambda) by controlling the air intake amount of the engine (ENG) to also reduce the input fuel amount of the engine (ENG) (in an operation S115).

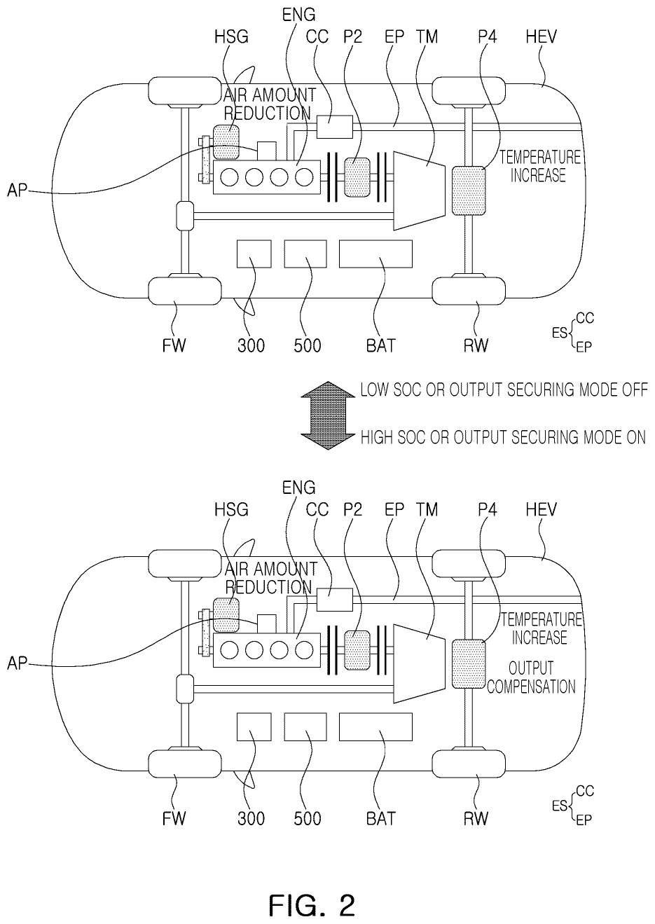

Referring to FIG. 2 and FIG. 5, in operation S 121, S123 and S124, the controller 500 may determine whether the motor P2 compensates for at least a portion of the torque reduction of the engine (ENG) based on whether the torque securing mode is activated (i.e., “ON” S121). For example, the torque securing mode may be a sports mode in which the overall torque of the hybrid electric vehicle (HEV) is increased and may be set by the driver via a mode setting input (for example, a button input, or a touch panel input) to the input/output device of the controller 500 in advance. Depending on the design, the torque securing mode may be implemented as an initial setting mode or may be implemented so that the activation or not may not be changed (S121 of FIG. 5 omitted).

In operation S122, the controller 500 may determine whether the state of charge (SOC) of the battery (BAT) exceeds a predetermined reference value and control the torque of the motor P2 to compensate for at least a portion of the torque reduction of the engine (ENG) based on the state of charge (SOC) of the battery (BAT) (i.e., when “YES” in S122).

Accordingly, the state of charge of the battery (BAT) may be prevented from becoming too low, the battery (BAT) may be more easily managed within the range of an appropriate state of charge (for example, 50% to 80%), the lifespan of the battery (BAT) may be further extended, and the safety of the battery (BAT) may be further improved. The battery (BAT) may quickly lose its life when its state of charge becomes too low, and the higher the value of the total usage time divided by the time within the appropriate charge state range (for example, 50% to 80%), the longer and safer the battery (BAT) may be used.

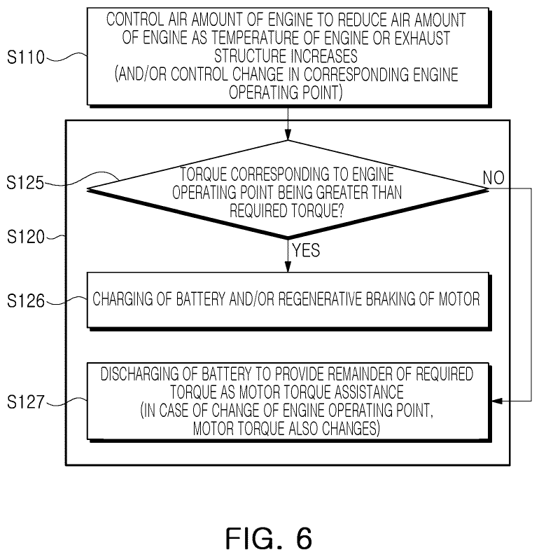

Referring to FIG. 1A and FIG. 6, in operation S126, the controller 500 may control charging of the battery (BAT) when the torque of the engine (ENG) (for example, torque corresponding to the optimal operating point of the engine, torque corresponding to the efficiency optimal point of the engine), which was reduced due to a decrease in the air intake amount, is equal to or greater than the required torque (“YES” in S125). When the reduced torque of the engine is less than the required torque (“NO” in S125), the controller 500 may control discharging of the battery (BAT) (in an operation S127).

For example, the operation S120 may be performed by a Hybrid Control Unit (HCU) that may be included in the controller 500, and the controller 500 may perform cooperative control between the operation S110 and the HCU. For example, the operation S110 may be performed by an Engine Management System (EMS) that may be included in the controller 500, and thus, the controller 500 may perform mutual cooperative control between the HCU and the EMS.

For example, the sensor unit 300 may include an accelerator pedal sensor (APS) that senses the input of the accelerator pedal, and the controller 500 may generate a required torque value corresponding to the output value of the accelerator pedal sensor. For example, when the torque of the engine (ENG) is equal to or greater than the required torque, the controller 500 may reduce or stop the torque of the motor P2, charge the battery (BAT) through the hybrid starter generator (HSG), or charge the battery (BAT) through the regenerative braking of the motor. For example, when the torque of the engine (ENG) is less than the required torque, the controller 500 may allocate the required torque between the engine (ENG) and the motor P2. Depending on the design, the hybrid starter generator (HSG) may be implemented as a portion (which may be expressed as P0) of the motor or may be omitted.

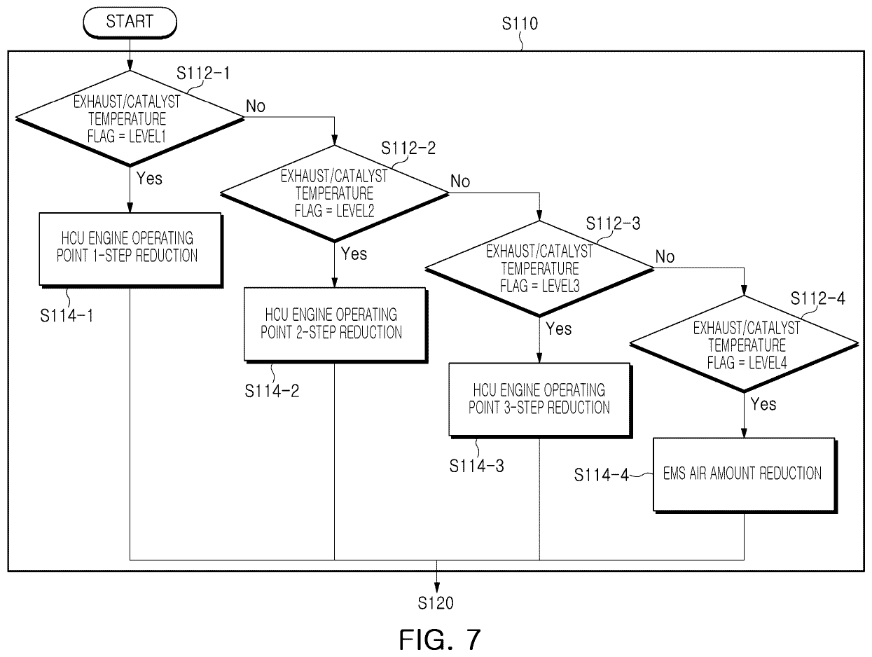

Referring to FIGS. 5 and 7, in the operation S110, the controller 500 may control the air intake amount (and/or input fuel amount) of the engine (ENG) so that as the temperature of the engine (ENG) or exhaust structure (ES) increases stepwise in operations S112-1, S112-2, S112-3, and S112-4 within a predetermined temperature range (for example, from a temperature 100 degrees Celsius lower than the limit temperature to the limit temperature), the air intake amount (and/or input fuel amount) of the engine (ENG) may be decreased stepwise in operations S114-1, S114-2, S114-3, and S114-4.

For example, the controller 500 may generate Flag data by determining one of level 1, level 2, level 3, and level 4 based on the temperature (exhaust/catalyst temperature) of the engine and/or exhaust structure. For example, level 1 may be a temperature lower than 100 degrees Celsius lower than the limit temperature, level 2 may be a temperature between 100 degrees Celsius and 50 degrees Celsius lower than the limit temperature, level 3 may be a temperature between 50 degrees Celsius and 0 degrees Celsius lower than the limit temperature, and level 4 may be a temperature higher than the limit temperature. However, the number and boundaries of the temperature ranges are not limited. For example, the number and boundaries of the temperature ranges may be optimized through tests on an actual hybrid electric vehicle, and may be optimized according to the model/specification of the actual hybrid electric vehicle.

For example, the controller 500 may control the air intake amount of the engine (ENG) by changing or adjusting the operating point of the engine (ENG) as the temperature of the engine (ENG) or exhaust structure (ES) increases within a first temperature range (corresponding to level 1, level 2, and level 3 of FIG. 7) of a predetermined temperature range, and may control the air intake amount of the engine (ENG) with greater priority than the operating point adjustment as the temperature of the engine (ENG) or exhaust structure (ES) increases within a second temperature range (corresponding to level 4 of FIG. 7) of the predetermined temperature range. Accordingly, the controller 500 may more efficiently secure the purification rate for exhaust gas in the first temperature range (corresponding to level 1, level 2, and level 3 of FIG. 7) or more efficiently secure (or improve) the overall torque of the hybrid electric vehicle, and may more stably prevent the engine and/or exhaust structure from being damaged by high temperature in the second temperature range (corresponding to level 4 of FIG. 7).

For example, the HCU of the controller 500 may change the operating point of the engine (ENG) by applying the temperature as a weight to the optimal operating point included in the stored optimal operating point data (for example, the corresponding relationship map data between the required torque and the engine RPM) or by switching between a plurality of optimal operating points included in the optimal operating point data. For example, the EMS of the controller 500 may forcibly control the air intake amount of the engine (ENG) while maintaining the operating point of the engine (ENG), in a second temperature range (corresponding to level 4 in FIG. 7) that is higher than the first temperature range (corresponding to level 1, level 2, and level 3 in FIG. 7).

For example, the Hybrid Control Unit (HCU) and/or the Engine Management System (EMS) of the controller 500 may change the engine operating point or reduce the air intake amount, based on the Flag data. Depending on the design (for example, test results and model/specification of a hybrid electric vehicle), changing the engine operating point may be replaced by reducing the intake air amount, and reducing the intake air amount may be replaced by changing the engine operating point.

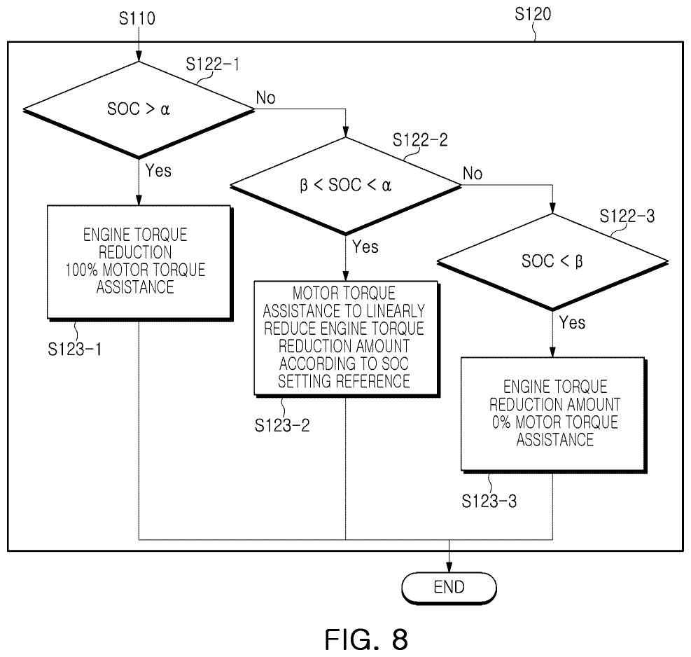

Referring to FIGS. 2, 5 and 8, in the operation S123-2, the controller 500 may determine a compensation ratio, at which the motor P2 compensates for at least a portion of the torque reduction of the engine (ENG), in proportion to the state of charge (SOC) of the battery (BAT), when the state of charge (SOC) of the battery (BAT) is lower than the first reference “α” and higher than the second reference “β” (“Yes” in an operation S122-2). In an operation S123-1, the controller 50 may determine the compensation ratio, at which the motor P2 compensates for at least a portion of the torque reduction of the engine (ENG), to be the maximum (for example, 100%), when the state of charge (SOC) of the battery (BAT) is higher than the first reference α (“Yes” in an operation S122-1). In an operation S123-3, the controller 500 may determine the compensation ratio, at which the motor P2 compensates for at least a portion of the torque reduction of the engine (ENG), to be a minimum (for example, 0%) when the state of charge (SOC) of the battery (BAT) is lower than the second reference β.

Accordingly, the compensation ratio that the motor P2 compensates for at least a portion of the torque reduction of the engine (ENG) may be continuously changed according to the change in the state of charge (SOC) of the battery (BAT), and thus, the inconsistency in the acceleration feeling felt by the driver when applying pressure to the accelerator pedal (for example, the heterogeneity due to the difficulty of the driver in recognizing the state of charge) may be reduced.

Referring to FIG. 1B, the motor (P1 and/or P2) may include a first motor P1 and/or a second motor P2, and may provide torque to only one of a front wheel (FW) and a rear wheel (RW) of a two-wheeled hybrid electric vehicle (HEV). For example, the first motor P1 may be connected to a crank shaft of an engine (ENG), and a rotational speed of the first motor P1 may be the same as a rotational speed of the engine (ENG). The second motor P2 may be connected to a gear input shaft of a transmission (TM). A clutch may be connected between the first motor P1 and the second motor P2.

Referring to FIG. 1C, the motor (P2 and/or P4) may include at least one of a first motor P4 that provides torque to a rear wheel (RW) of a hybrid electric vehicle (HEV) and a second motor P2 that is connected between an engine (ENG) and a transmission (TM) and provides torque to a front wheel (FW) of the hybrid electric vehicle (HEV). The arrangement structure of the motors of FIGS. 1A to 1C may be defined as a Transmission Mounted Electric Device (TMED), but the hybrid electric vehicle (HEV) is not limited to a TMED. Depending on the design, the first motor P4 may be omitted.

The first motor P4 may provide torque to one (for example, the rear wheel) of the front wheel (FW) and the rear wheel (RW) of the hybrid electric vehicle (HEV). For example, the first motor P4 may be connected to the power shaft of the rear wheel (RW), may be disposed rearwardly from the center of the hybrid electric vehicle (HEV), and may be disposed closer to the rear wheel (RW) than to the front wheel (FW).

The second motor P2 may provide torque to the other (for example, the front wheel) of the front wheel (FW), while the first motor provides the torque to the rear wheel (RW) of the hybrid electric vehicle (HEV). For example, the second motor P2 may be disposed between the engine (ENG) and the transmission (TM), may be permanently coupled to the transmission (TM), and may provide torque to the front wheel (FW) through the transmission (TM). The second motor P2 may be connected to the gear input shaft of the hybrid electric vehicle (HEV), but is not limited thereto.

For example, each of the first and second motors P4 and P2 may be implemented as an induction motor, a permanent magnet synchronous motor, or the like, and may further include a power converter (for example, an inverter and/or a rectifier) that converts between direct current and alternating current, and may further include a motor controller that controls the operation of the power converter (for example, on-off operation of a plurality of switches constituting the power converter). Depending on the design, the motor controller may be implemented as at least a portion of the controller 500.

The hybrid electric vehicle (HEV) may be configured so that the torques respectively provided by the first and second motors P4 and P2 are independent of each other (for example, not connected between the power shaft of the rear wheel and the transmission (TM)). For example, the motor controller and/or controller 500 may consider the torque relationship (for example, torque distribution or the like) between the first and second motors P4 and P2 in the process of determining the torque of each of the first and second motors P4 and P2 (for example, calculating the torque value according to the control logic), but the first and second motors P4 and P2 may respectively, independently provide the determined torque to the rear wheel (RW) and the front wheel (FW). Accordingly, the first and second motors P4 and P2 may selectively provide one selected from among rear-wheel drive that drives only the rear wheels (RW), front-wheel drive that drives only the front wheels (FW), and four-wheel drive that drives both the rear wheels (RW) and the front wheels (FW), depending on the situation/state of the hybrid electric vehicle (HEV).

For example, the controller 500 may secure the stability of the hybrid electric vehicle (HEV) by controlling the four-wheel drive when the hybrid electric vehicle (HEV) is driven in an area with a low road friction coefficient or when the steering angle is increased, and may improve the energy efficiency of the hybrid electric vehicle (HEV) by controlling the two-wheel drive when the hybrid electric vehicle (HEV) is driven in an area with a high road friction coefficient or when driving straight. For example, the controller 500 may control the distribution between the torque value to be provided by the first motor P4 and the torque value to be provided by the second motor P2 when controlling the four-wheel drive, for example, using attitude control (vehicle dynamic control, VDC) and/or Traction Control System (TCS).

The first and second motors P4 and P2 may efficiently provide torque when the speed of the hybrid electric vehicle (HEV) is low, and the engine (ENG) may efficiently provide torque when the speed of the hybrid electric vehicle (HEV) is high. Therefore, the hybrid electric vehicle (HEV) may have both the advantages of an efficient engine (ENG) at high speeds and the advantages of efficient first and second motors P4 and P2 at low speeds. Alternatively, the hybrid electric vehicle (HEV) may use both the fuel supply source used by the engine (ENG) and the electric energy supply source used by the first and second motors P4 and P2, and thus it may also be advantageous in improving the stability/efficiency of energy supply.

The battery (BAT) may provide energy to at least one of the first and second motors P4 and P2. For example, the battery (BAT) may be implemented as a high-voltage battery (for example, rated voltage of 300 V to 400 V) and may be implemented as one or more battery packs.

For example, the battery (BAT) may output DC power to a power converter (for example, an inverter) of at least one of the first and second motors P4 and P2. When at least one of the first and second motors P4 and P2 performs regenerative braking, the energy generated through at least one of the first and second motors P4 and P2 may be converted into DC power by the power converter (for example, a rectifier) and charged to the battery (BAT).

For example, the battery (BAT) may include a battery management system (BMS), and the battery management system may monitor at least one of the current, voltage, and temperature of the battery (BAT), generate charge state data based on the monitoring result, and transmit the charge state data to the controller 500. Accordingly, the controller 500 may know the state of charge of the battery (BAT). Depending on the design, at least a portion of the battery management system may be included in the controller 500.

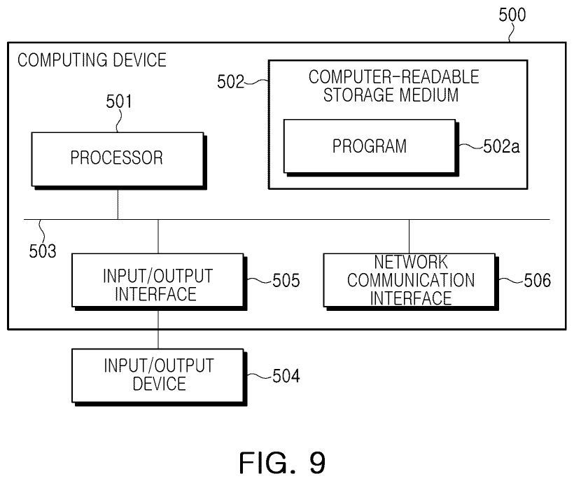

Meanwhile, referring to FIG. 9, the controller 500 of the device for controlling a hybrid electric vehicle according to the disclosed embodiment may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing the method of controlling a hybrid electric vehicle according to the disclosed embodiment. The communication bus 503 may include the processor 501 and the computer-readable storage medium 502 and interconnect other various components of the computing device 500.

The processor 501 may cause the controller 500 to operate according to the example embodiment mentioned above. For example, the processor 501 may execute one or more programs stored in the computer-readable storage medium 502. The one or more programs may include one or more computer-executable instructions, and when the computer-executable instruction is executed by the processor 501, the processor may be configured to enable the controller 500 to perform operations according to an example embodiment.

The computer-readable storage medium 502 may be configured to store computer-executable instructions, program code, program data, and/or other suitable forms of information. The program 502a stored on the computer-readable storage medium 502 includes a set of instructions executable by the processor 501. In an embodiment, the computer-readable storage medium 502 may be memory (volatile memory, such as random access memory, nonvolatile memory, or a suitable combination thereof), one or more magnetic disk storage devices, optical disk storage devices, flash memory devices, or other forms of storage media that are accessible by the controller 500 and capable of storing required information, or suitable combinations thereof.

The controller 500 may also include one or more input/output interfaces 505 providing interfaces for one or more input/output devices 504 and one or more network communication interfaces 506. The input/output interface 505 and the network communication interface 506 are connected to a communication bus 503. The network may be any one of a cellular network, such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), 5G, Wi-Fi, or another cellular network, and may also be implemented as Ethernet, Media Oriented Systems Transport (MOST), Flexray, Controller Area Network (CAN), Local Interconnect Network (LIN), Internet, Bluetooth, Near Field Communication (NFC), Zigbee, Radio Frequency (RF), or the like.

The input/output device 504 may be connected to other components of the controller 500 via the input/output interface 505. The example input/output devices 504 may include input devices such as pointing devices (such as a mouse or trackpad), keyboards, touch input devices (such as a touchpad or a touchscreen), voice or sound input devices, various types of sensor devices and/or photographing devices, and/or output devices such as display devices, printers, speakers, and/or network cards. The example input/output devices 504 may be included within the controller 500, as a component constituting the controller 500, or may be connected to the controller 500, as a separate device distinct from the controller 500.

Meanwhile, the disclosed embodiment may include a program for executing the methods described herein on a computer, and a computer-readable recording medium including the program. The computer-readable recording medium may include program instructions, local data files, local data structures, and the like, alone or in combination. The medium may be specially designed and configured for the disclosed embodiment, or may be commonly available in the field of computer software. Examples of computer-readable recording media include magnetic media such as hard disks, floppy disks, and magnetic tapes, optical recording media such as CD-ROMs and DVDs, and hardware devices specifically configured to store and execute program instructions, such as ROMs, RAMs, and flash memories. Examples of such programs may include not only machine language codes such as those generated by a compiler, but also high-level language codes that may be executed by a computer using an interpreter or the like.

As set forth above, a device and method for controlling a hybrid electric vehicle according to an embodiment, and a hybrid electric vehicle and a storage medium including the same, may prevent an engine and/or an exhaust structure from being damaged by high temperature, while securing a purification rate for exhaust gas or securing (or improving) the overall torque of the hybrid electric vehicle, and stably securing (or improving) the acceleration feeling felt by a driver when applying pressure to an accelerator pedal.

While the embodiments have been shown and described above, it should be apparent to those having ordinary skill in the art that modifications and variations could be made without departing from the scope of the present disclosure as defined by the appended claims.

What is claimed is:

1. A device for controlling a hybrid electric vehicle, the device comprising:
a controller configured to:
control an air intake amount of an engine such that the air intake amount decreases as a temperature of the engine or a temperature of an exhaust structure of the hybrid electric vehicle increases, and
control a torque of at least one motor, which outputs torque based on energy from a battery of the hybrid electric vehicle, to compensate for at least a portion of a torque reduction of the engine caused by a decrease in the air intake amount of the engine.

2. The device of claim 1, wherein the controller is configured to control a lambda value, defined as a ratio of an actual air-fuel ratio to a theoretical air-fuel ratio, to track or maintain a value of 1.

3. The device of claim 2, wherein the controller configured to control the air intake amount and an input fuel amount of the engine such that the air intake amount and the input fuel amount of the engine decrease stepwise as the temperature of the engine or the temperature of the exhaust structure increases stepwise within a predetermined temperature range.

4. The device of claim 1, wherein the controller is configured to:
control the air intake amount of the engine by adjusting an operating point of the engine as the temperature of the engine or the exhaust structure increases within a first temperature range of a predetermined temperature range, and
control the air intake amount of the engine with greater priority than the operating point adjustment as the temperature of the engine or the exhaust structure increases within a second temperature range of the predetermined temperature range.

5. The device of claim 1, wherein the controller is configured to determine, based on a state of charge (SOC) of the battery, whether the at least one motor is configured to compensate for at least a portion of the torque reduction of the engine.

6. The device of claim 5, wherein the controller is configured to control the torque of the at least one motor such that a compensation ratio, at which the at least one motor compensates for at least the portion of the torque reduction of the engine, is determined based on the SOC of the battery.

7. The device of claim 1, wherein the controller is configured to determine whether the at least one motor compensates for at least a portion of the torque reduction of the engine based on whether a torque securing mode is activated.

8. The device of claim 1, wherein the at least one motor includes: a first motor configured to provide a torque to rear wheels, and a second motor connected between the engine and a transmission and configured to provide a torque to front wheels of the hybrid electric vehicle, and
the controller is configured to control torque of at least one of the first motor or the second motor to compensate for at least a portion of the torque reduction of the engine.

9. The device of claim 1, wherein the controller is configured to:
control charging of the battery when a torque of the engine, reduced due to reduction in the air intake amount, is equal to or greater than a required torque, and
control discharging of the battery when the torque of the engine, reduced due to the reduction in the air intake amount, is less than the required torque.

10. A hybrid electric vehicle comprising:
an engine;
an exhaust structure forming an exhaust path of the engine;
a sensor unit configured to sense a temperature of the engine and the exhaust structure;
a battery;
at least one motor configured to output a torque based on energy from the battery; and
a controller configured to:
control an air intake amount of the engine such that the air intake amount decreases as a temperature of the engine or a temperature of the exhaust structure increases, and
control the torque of the at least one motor to compensate for at least a portion of torque reduction of the engine caused by a decrease in the air intake amount of the engine.

11. The hybrid electric vehicle of claim 10, wherein the controller is configured to determine at least one of whether the at least one motor compensates for at least the portion of the torque reduction of the engine or a compensation ratio, based on a state of charge (SOC) of the battery.

12. The hybrid electric vehicle of claim 11, wherein the controller is configured to:
control the air intake amount of the engine such that an input fuel amount of the engine decreases as the temperature of the engine or the exhaust structure increases, and
control a lambda value, defined as a ratio of an actual air-fuel ratio to a theoretical air-fuel ratio, to track or maintain a value of 1.

13. The hybrid electric vehicle of claim 12, wherein the controller is configured to control the air intake amount and the input fuel amount of the engine such that the air intake amount and the input fuel amount of the engine decrease stepwise as the temperature of the engine or the temperature of the exhaust structure increases stepwise within a predetermined temperature range.

14. The hybrid electric vehicle of claim 12, wherein the controller is configured to:
control charging of the battery when a torque of the engine, decreased due to a decrease in the air intake amount, is equal to or greater than a required torque, and
control discharging of the battery when the torque of the engine, decreased due to the decrease in the air intake amount, is less than the required torque.

15. The hybrid electric vehicle of claim 14, wherein the at least one motor includes: a first motor configured to provide a torque to rear wheels, and a second motor connected between the engine and a transmission and configured to provide a torque to front wheels of the hybrid electric vehicle, and
the controller is configured to control the torque of at least one of the first motor or the second motor to compensate for at least a portion of the torque reduction of the engine.

16. A method for controlling a hybrid electric vehicle, the method comprising:
controlling an air intake amount of an engine to reduce the air intake amount as a temperature of the engine or a temperature of an exhaust structure of the hybrid electric vehicle increases; and
controlling a torque of a motor configured to output the torque based on energy from a battery of the hybrid electric vehicle to compensate for at least a portion of torque reduction of the engine caused by a decrease in the air intake amount of the engine.

17. The method of claim 16, wherein controlling the torque of the motor includes: determining at least one of whether the motor compensates for at least the portion of the torque reduction of the engine or a compensation ratio based on a state of charge (SOC) of the battery.

18. The method of claim 17, wherein controlling the air intake amount includes: decreasing the air intake amount of the engine stepwise as the temperature of the engine or the exhaust structure increases stepwise within a predetermined temperature range, and
wherein controlling the torque of the motor includes:
determining a compensation ratio at which the motor compensates for at least a portion of the torque reduction of the engine in proportion to the SOC of the battery based on determining that the SOC of the battery is lower than a first reference and higher than a second reference,
setting the compensation ratio to a maximum value based on determining that the SOC of the battery is higher than the first reference, and
setting the compensation ratio to a minimum value based on determining that the SOC of the battery is lower than the second reference.

19. The method of claim 16, wherein controlling the torque of the motor includes:
controlling the air intake amount of the engine such that an input fuel amount of the engine decreases as the temperature of the engine or the exhaust structure increases, and
performing lambda control such that a lambda value obtained by dividing an actual air-fuel ratio by a theoretical air-fuel ratio follows a value of 1.

20. A non-transitory computer-readable storage medium storing instructions that, when executed by a processor, cause the processor to perform the method of claim 16.
